(19) United States
(12) Patent Application Publication
(10) Pub. No.: US 2015/0027097 A1
(43) Pub. Date: Jan. 29, 2015

(54) CONNECTION DEVICE FOR AN ATTACHMENT OF A SELF-PROPELLED WORK MACHINE

(71) Applicant: BISO SCHRATTENECKER GMBH, Ort im Innkreis (AT)

(72) Inventor: Franz Schrattenecker, Eggerding (AT)

(21) Appl. No.: 14/357,668

(22) PCT Filed: Nov. 12, 2012
(86) PCT No.: PCT/EP2012/004698

§ 371 Date: Sep. 17, 2014

(30) Foreign Application Priority Data
Nov. 14, 2011 (DE) 10 2011 118 510.4

(51) Int. Cl. A01D 41/12; A01D 41/02; A01D 41/06; F16C 11/04

(52) U.S. Cl. CPC A01D 41/12; F16C 11/04; A01D 41/02; A01D 41/06
USPC 56/13.5; 403/53

(57) ABSTRACT

The invention relates to an improved connection device for an attachment of a self-propelled work machine, comprising a first pivot lever (13), a second pivot lever (14), and a third pivot lever (15). The first pivot lever (13) can be or is connected to the work machine such as to be drivable (18) and pivotable (27). The second pivot lever (14) is connected to the first pivot lever (13) such as to be drivable (28) and pivotable (27). The third pivot lever (15) is connected to the second pivot lever (14) such as to be drivable (32) and pivotable (31) and can be or is connected (29) to the attachment. The pivot pins (27, 31) of the second pivot lever (14) are vertically adjustable relative to one another.

The invention relates to a connecting device for an attachment of a self-propelled working machine.

The self-propelled working machine in particular is a towing vehicle, a tractor or a combine-harvester.

The attachment in particular can be a harvesting attachment. The harvesting attachment can include a frame and side walls. It can serve for accommodating various harvesting tools, for example for accommodating a cutting unit. The harvesting attachment can comprise a cutting unit, a reel, a cutter bar, crop divider and/or side cutter and/or further required components. Usually, the harvesting attachment is connectable or connected to the front side of a harvesting machine, in particular of a combine-harvester. The harvesting attachment can comprise a corn adapter.

When a self-propelled working machine with a wide attachment must be moved on a road, the problem can arise that the width of the attachment is greater than the admissible width, in particular greater than the width allowed on public roads or the width possible because of lateral obstacles along the road. According to a known procedure, the attachment is demounted from the working machine and transported separately. However, this involves a considerable expenditure.

Proceeding therefrom, it is the object of the invention to render demounting of the attachment from the self-propelled working machine superfluous, in particular for road transport.

According to the invention, this object is solved by the features of claim 1. The connecting device comprises a first pivot lever which is drivably pivotally connectable or connected with the working machine, a second pivot lever which is drivably pivotally connected with the first pivot lever, and a third pivot lever which is drivably pivotally connected with the second pivot lever and which is connectable or connected with the attachment, wherein the pivot axes of the second pivot lever are vertically adjustable relative to each other.

This design provides for pivoting a part of the attachment upwards and/or downwards and for positioning the same above and/or below another part of the attachment. This leads to a reduction of the width of the attachment.

The first pivot lever is pivotally connected with the working machine about a substantially vertical axis. This axis is drivable. In particular, it is drivable hydraulically or electrically.

The second pivot lever is pivotally connected with the first pivot lever about a substantially vertical axis. This axis is drivable. In particular, it is drivable hydraulically or electrically.

The third pivot lever is pivotally connected with the second pivot lever about a substantially vertical axis. This axis is drivable. In particular, it is drivable hydraulically or electrically.

Advantageous developments are described in the sub-claims.

Advantageously, the second pivot lever is formed as multiple joint, in particular as four-bar linkage with four struts.

The second pivot lever can comprise two vertical struts and two horizontal struts, which are articulated to each other. Preferably, the four struts are articulated to each other in a ring.

A further advantageous development is characterized by a drivable adjusting rod which is articulated to two struts of the second pivot lever. The adjusting rod preferably is connected with two opposed struts of the second pivot lever. Preferably, the drivable adjusting rod is connected with the two horizontal struts of the second pivot lever. The adjusting rod preferably is adjustable in length. Preferably, it is drivable hydraulically or electrically.

The invention furthermore relates to an attachment for a self-propelled working machine with a connecting device according to the invention, a self-propelled working machine, in particular a combine-harvester, with a connecting device according to the invention and a self-propelled working machine, in particular a combine-harvester, with an attachment and a connecting device according to the invention.

An exemplary embodiment of the invention will be explained in detail below with reference to the attached drawings, in which:

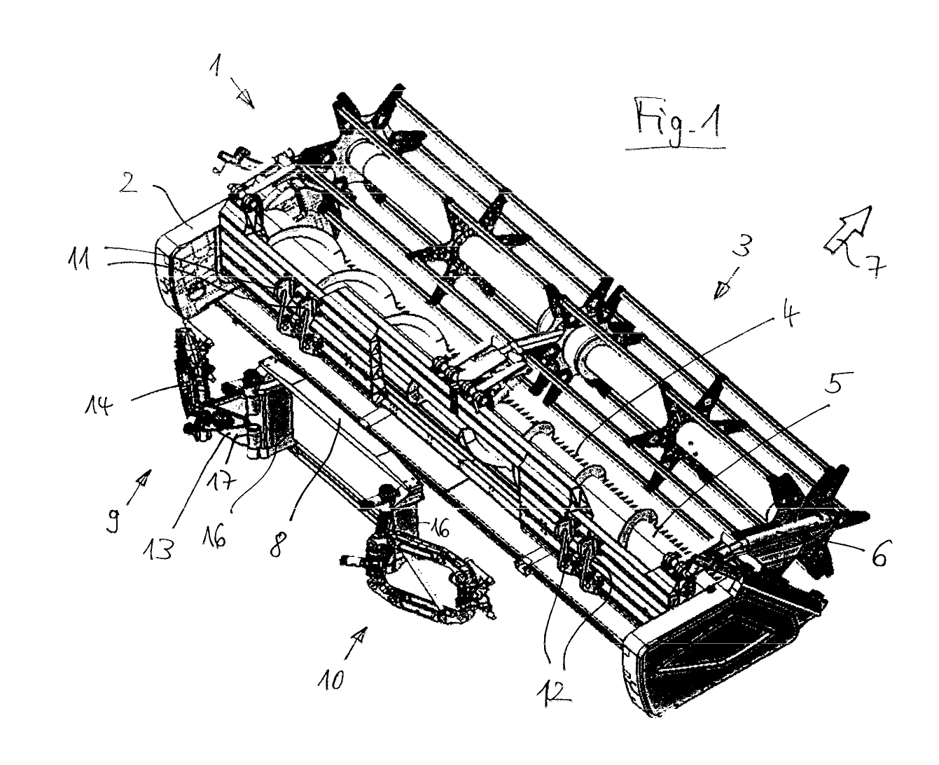

FIG. 1 shows a harvesting attachment and a connecting device in working position in a perspective representation,

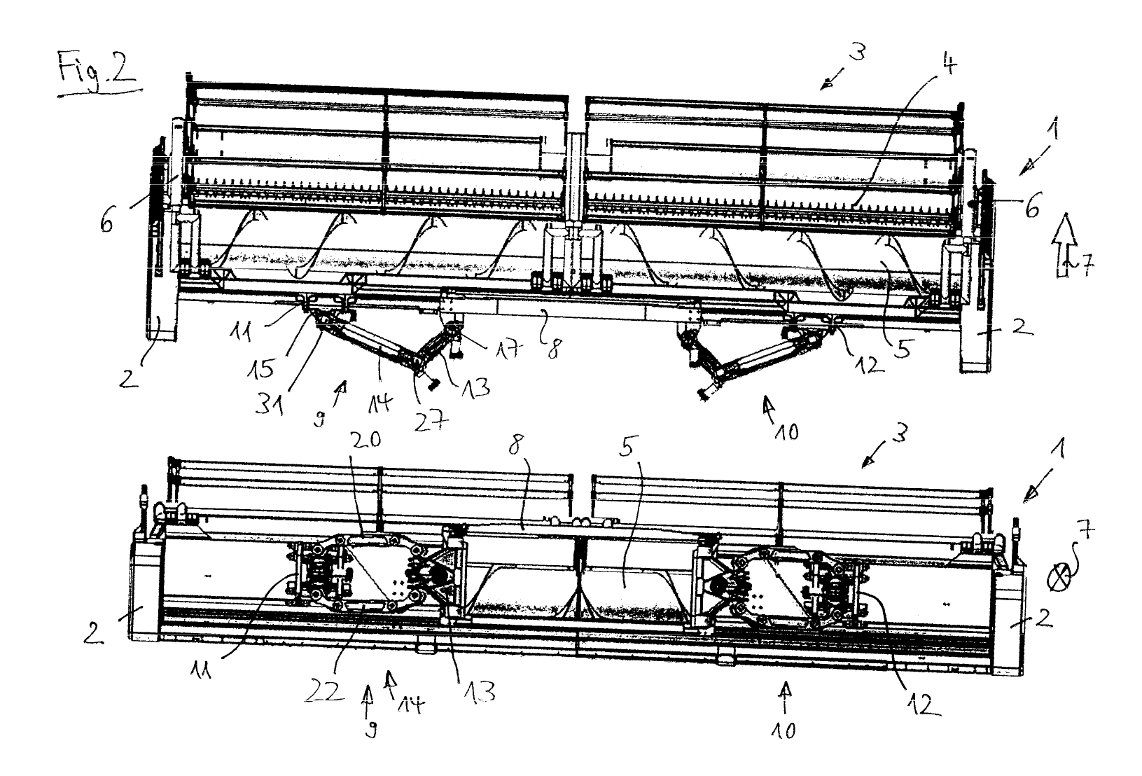

FIG. 2 shows the harvesting attachment according to FIG. 1 in working position in a view from the top (upper representation) and in a view from the rear (lower representation),

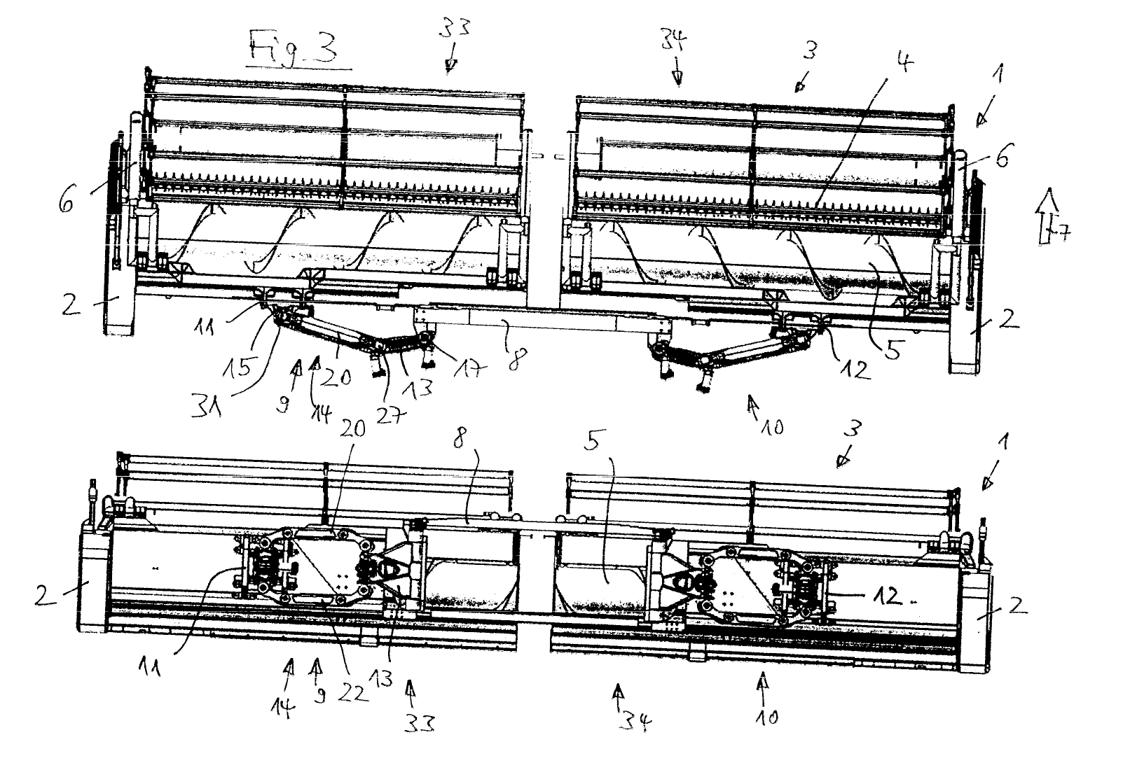

FIG. 3 shows the harvesting attachment according to FIGS. 1 and 2 in a partly extended position in a view from the top (upper representation) and in a view from the rear (lower representation),

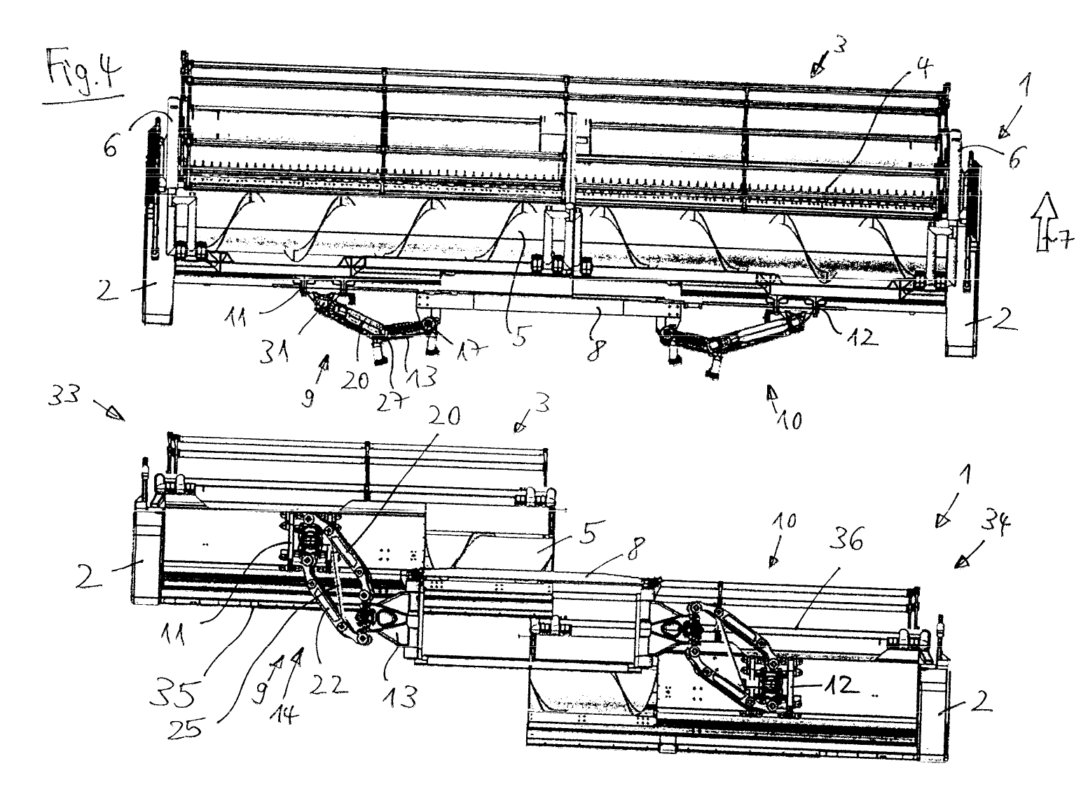

FIG. 4 shows the harvesting attachment according to FIGS. 1 to 3 in a position partly pivoted upwards and downwards in a view from the top (upper representation) and in a view from the rear (lower representation),

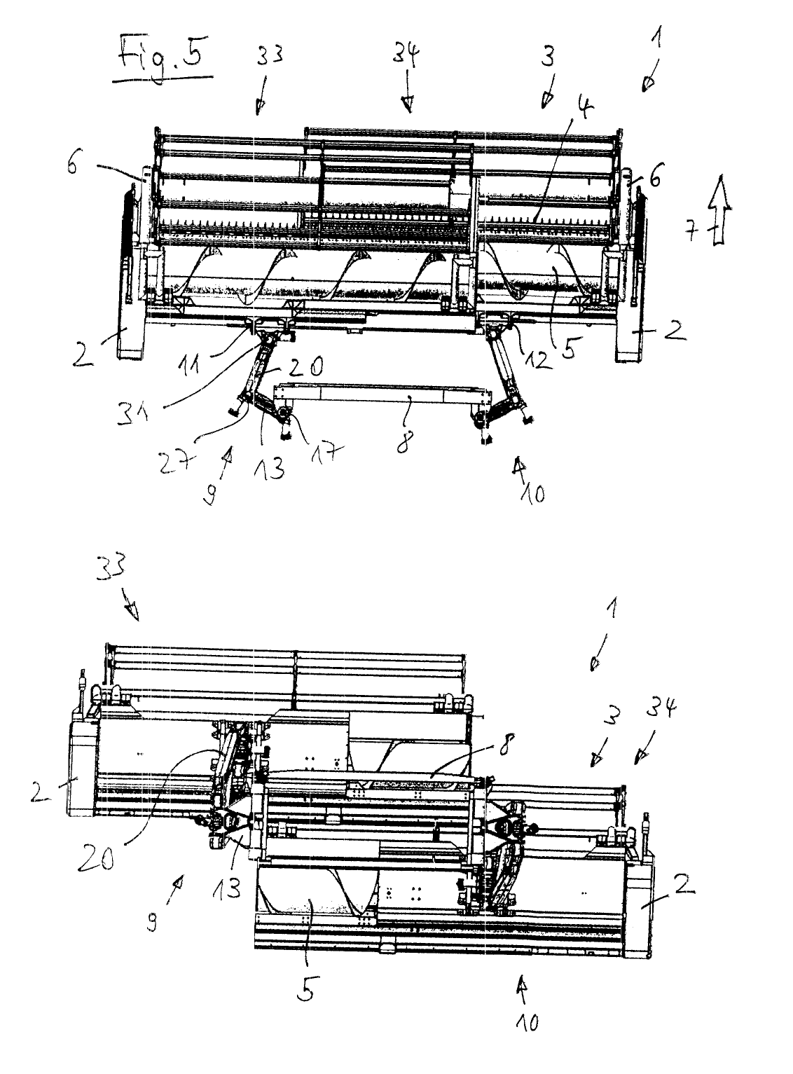

FIG. 5 shows the harvesting attachment according to FIGS. 1 to 4 in position partly pushed one over the other in a view from the top (upper representation) and in a view from the rear (lower representation),

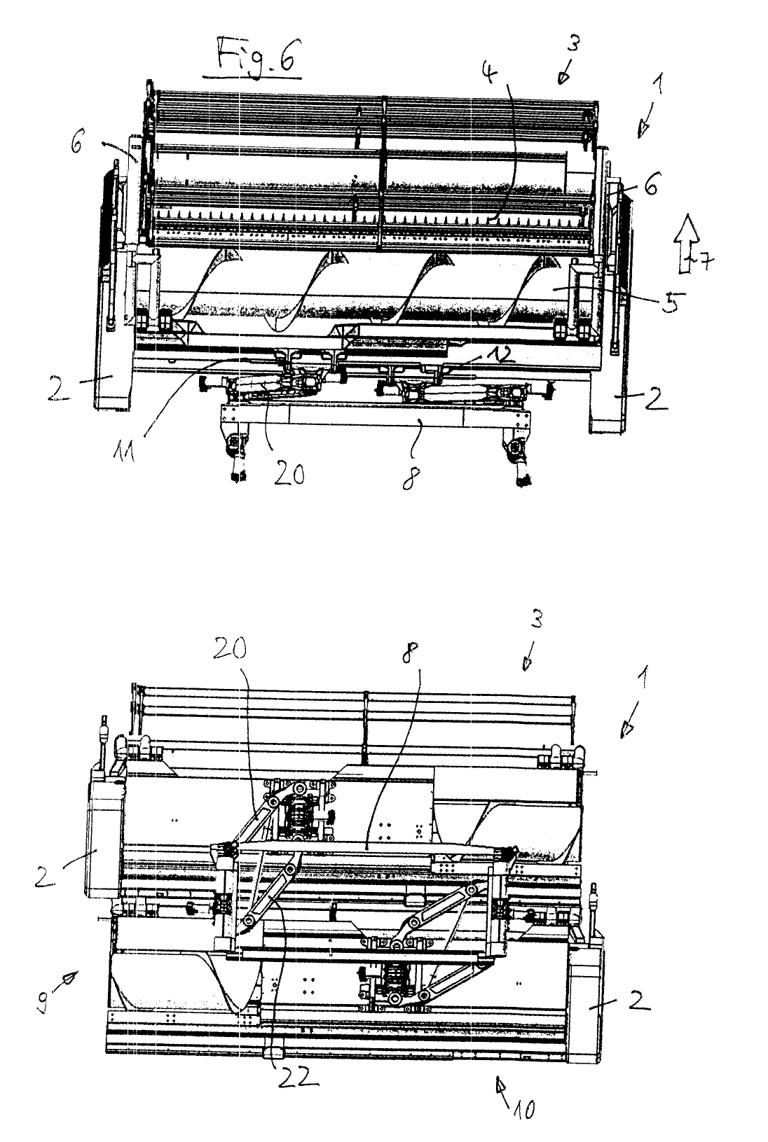

FIG. 6 shows the harvesting attachment according to FIGS. 1 to 5 in position completely pushed one over the other (transport position) in a view from the top (upper representation) and in a view from the rear (lower representation),

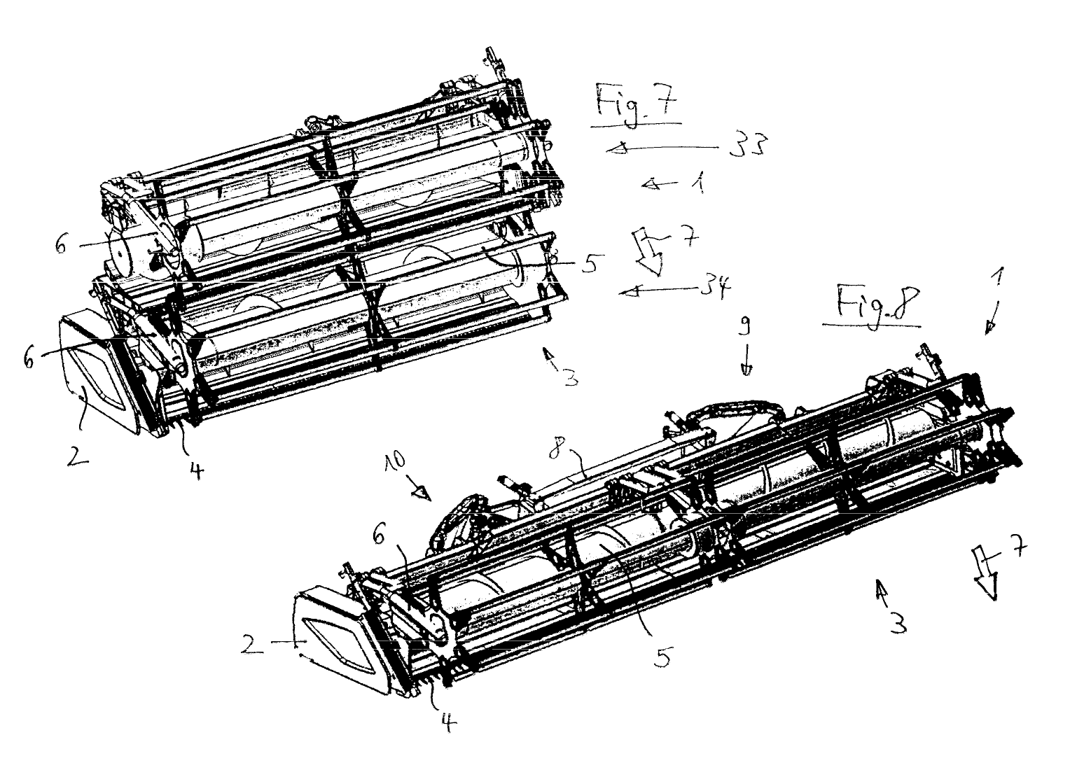

FIG. 7 shows the harvesting attachment according to FIGS. 1 to 6 in the position according to FIG. 6 (transport position) in a perspective representation,

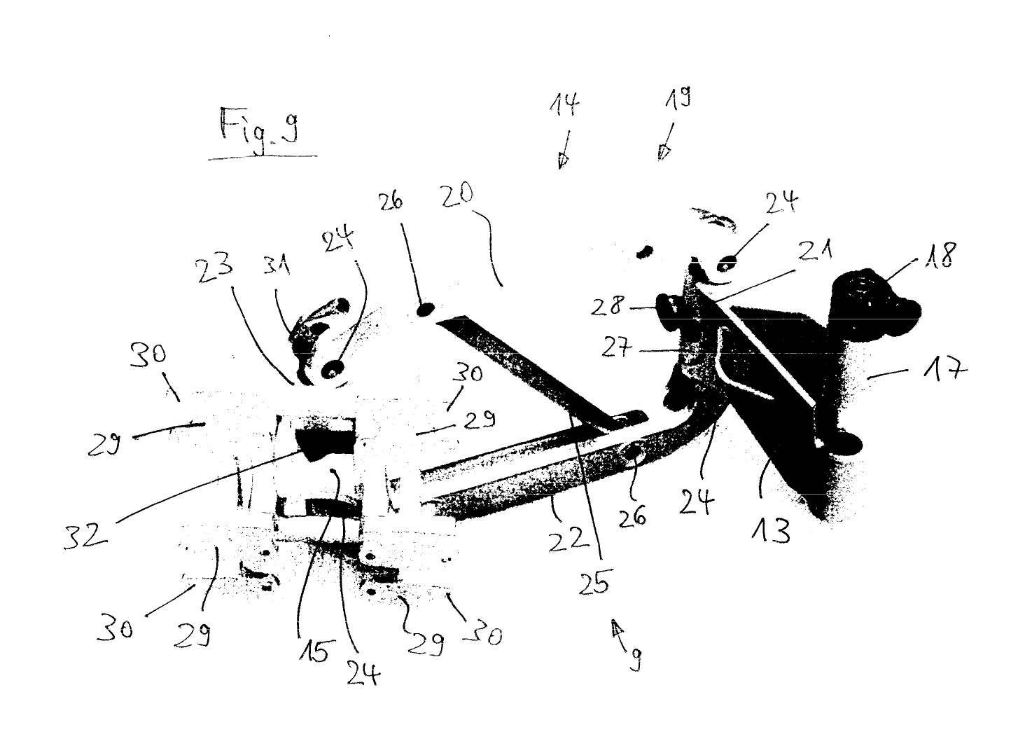

FIG. 8 shows the harvesting attachment according to FIGS. 1 to 7 in a position corresponding to FIGS. 1 and 2 (working position) in a perspective view,

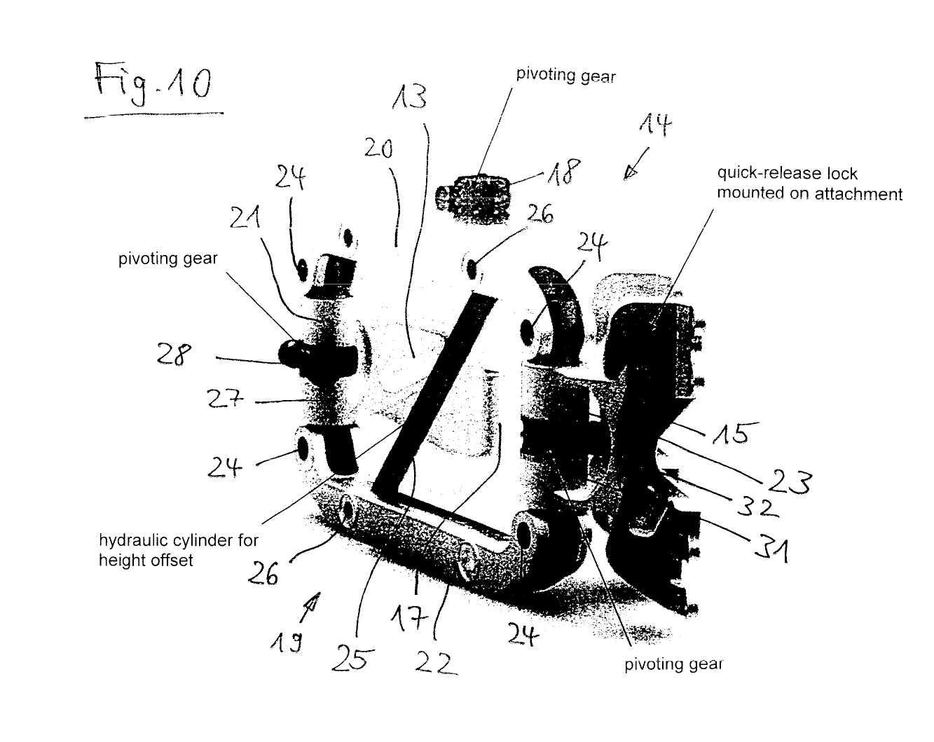

FIG. 9 shows the second pivot lever of the connecting device according to FIGS. 1 to 8 in a perspective representation, and

FIG. 10 shows the second pivot lever according to FIG. 9 in a further perspective representation.

FIG. 1 shows an attachment, namely a harvesting attachment 1, for a self-propelled working machine, namely for a combine-harvester. The harvesting attachment 1 comprises a housing with side walls 2, a reel 3, a mowing bar 4 and an intake auger 5. The reel 3 is rotatably mounted on supporting arms 6, which are pivotally mounted at the side wall 2.

The harvesting attachment 1 can be attached to the front side of the combine-harvester. It is then moved in working direction 7. The width of the harvesting attachment 1 substantially corresponds to the horizontal distance of its side walls 2.

At its front end, the combine-harvester has a mounting frame 8. The mounting frame 8 can form an integral part of the combine-harvester. It can, however, also firmly or releasably be connected with the combine-harvester.

With the mounting frame 8 a left connecting device 9 and a right connecting device 10 are connected. At its other end, the left connecting device 9 is connectable with two left mounting bars 11, which are part of the harvesting attachment 1, in particular of its housing, or which otherwise are firmly or releasably connected with the harvesting attachment 1. The other ends of the right connecting device are connectable with two corresponding right mounting bars 12.

FIG. 9 shows the left connecting device 9 in an enlarged perspective representation. The right connecting device 10 is designed in a similar or identical way and need therefore not be described separately.

The connecting device 9 comprises a first pivot lever 13, a second pivot lever 14 and a third pivot lever 15.

The first pivot lever 13 is pivotally connected with the vertical frame part 16 of the mounting frame 8 of the combine-harvester about a vertical axis 17. The vertical axis 17 includes a pivoting gear 18, by which it can be driven.

The second pivot lever 14 is formed as multiple joint, namely as four-bar linkage 19. The four-bar linkage 19 comprises four struts 20, 21, 22, 23, namely an upper horizontal strut 20, a first vertical strut 21, a lower horizontal strut 22, and a second vertical strut 23. The struts 20, 21, 22, 23 are articulated to each other in a ring 24. One end of the upper horizontal strut 20 is connected with the upper end of the first vertical strut 21 by a joint 24. The lower end of the first vertical strut 21 is connected with an end of the lower horizontal strut 22 by a joint 24. The other end of the lower horizontal strut 22 is articulated to the lower end of the vertical strut 23 by a joint 24. The upper end of the vertical strut 23 is connected with the other end of the upper horizontal strut 20 by a joint 24.

The second pivot lever 14 furthermore comprises a drivable adjusting rod 25. One end of the drivable adjusting rod 25 is connected with the upper horizontal strut 20 by a joint 26. The other end of the drivable adjusting rod 25 is connected with the lower horizontal strut 22 by a further joint 26. The joint 26 of the upper horizontal strut 20 is located closer to the joint 24 which connects the upper horizontal strut 20 with the second vertical strut 23 than to the joint 24 which connects the upper horizontal strut 20 with the first vertical strut 21. The joint 26 of the lower horizontal strut 22 is located closer to the joint 24 which connects the lower horizontal strut 22 with the first vertical strut 21 than to the joint 24 which connects the lower horizontal strut 22 with the second vertical strut 23. The drivable adjusting rod 25 thereby extends obliquely from the lower horizontal strut 22 to the upper horizontal strut 20. The adjusting rod 25 is adjustable in length. Its drive in particular can be designed as hydraulic drive, in particular as hydraulic piston-cylinder unit.

At its end facing away from the vertical axis 17, the second pivot lever 14 is pivotally connected with the first pivot lever 13 about a vertical axis 27. The vertical axis 27 corresponds with the first vertical strut 21 of the second pivot lever 14. Furthermore, the vertical axis 27 comprises a pivoting gear 28 by which the vertical axis 27 can be driven.

The third pivot lever 15 comprises connecting plates 29 which are connectable with the mounting bars 11 of the harvesting attachment 1 (see in particular FIG. 1). For this purpose, the connecting plates 29 include through holes 30 through which fastening screws can extend, which are screwed to the mounting bars 11 (not shown in the drawing).

The third pivot lever 15 is pivotally connected with the second pivot lever 14 about a vertical axis 31. The vertical axis 31 corresponds with the second vertical strut 23 of the second pivot lever 14. The vertical axis 31 can be driven by a pivoting gear 32.

The connecting device 9 has four degrees of freedom, namely a possibility for pivoting about the vertical axis 17, a possibility for pivoting about the vertical axis 27, a possibility for pivoting about the vertical axis 31, and a parallel displacement in height of the axes 27 and 31 by a length adjustment of the adjusting rod 25, which effects a parallel displacement of the vertical struts 21, 23 of the four-bar linkage 19 of the second pivot lever 14.

FIGS. 1 and 2 show the harvesting attachment 1 in working position. When the harvesting attachment 1 is to be brought into the transport position according to FIGS. 6 and 7, the left connecting device 9 is brought from the position shown in FIG. 2 into the position shown in FIG. 3. For this purpose, the first pivot lever 13 is pivoted in clockwise direction (as seen from above) about the vertical axis 17. The second pivot lever 14 is pivoted with respect to the first pivot lever 13 in counter-clockwise direction about the vertical axis 27. The third pivot lever 15 is pivoted with respect to the second pivot lever 14 in counter-clockwise direction about the vertical axis 31. The pivot levers of the right connecting device 10 are pivoted correspondingly, i.e. symmetrically to the pivoting movements of the pivot levers of the left connecting device 9. In this way, the two halves 33, 34 of the harvesting attachment 1 are moved away from each other in the way shown in FIG. 3. The left half 33 is moved to the left, and the right half 34 is moved to the right.

In a next step, the adjusting rod 25 of the second pivot lever 14 is lengthened. The four-bar linkage 19 of the second pivot lever 14 thereby is pivoted. Pivoting is effected such that the vertical struts 21, 23 still extend parallel to each other, but are offset to each other in height, as can be taken in particular from the lower representation in FIG. 4. In this way, the second vertical strut 23 of the four-bar linkage 19 of the left connecting device 9 and with it the left half 33 of the harvesting attachment 1 is moved upwards. Correspondingly, the second vertical strut of the four-bar linkage of the right connecting device 10 and with it the right half 34 of the harvesting attachment 1 is moved downwards. These movements up and down are carried out to such an extent that the lower end faces 35 of the left half 33 of the harvesting attachment 1 are located at a higher level than the upper end faces 36 of the right half 34 of the harvesting attachment 1.

In this way, it is ensured that the halves 33, 34 subsequently can be positioned vertically one above the other, as shown in FIG. 5. Proceeding from the position as shown in FIG. 4, the first pivot lever 13 of the left connecting device 9 is pivoted in clockwise direction about the vertical axis 17. The second pivot lever 14 likewise is pivoted in clockwise direction about the vertical axis 27. The third pivot lever 15 is pivoted in counter-clockwise direction about the vertical axis 31. In this way, the halves 33, 34 are moved towards each other. The left half 33 then is located above the right half 34.

The above-mentioned pivoting movements are continued, until the transport position shown in FIG. 6 is reached. The left half 33 here is located completely and substantially congruently above the right half 34. The width of the harvesting attachment, measured as distance of the side walls 2 from each other, substantially has halved.

The invention provides for transporting wide and exceptionally wide attachments. The connecting device according to the invention forms a universal folding unit which can be integrally mounted on a self-propelled working or towing machine and to which various attachments can be coupled. The connecting device comprises three pivot points or pivot axes, which provide for bringing a wide variety of widths of an attachment with a universal folding mechanism into the road transport position.

In principle, it would be possible that the vertical axis 17 of the left connecting device 9 and the corresponding vertical axis of the right connecting device 10 are identical with each other.

1. A connecting device for an attachment (1) of a self-propelled working machine, comprising
a first pivot lever (13) which is drivably (18) pivotally (17) connectable or connected with the working machine,
a second pivot lever (14) which is drivably (28) pivotally (27) connected with the first, pivot lever (13), and
a third pivot lever (15) which is drivably (32) pivotally (31) connected with the second pivot lever (14) and which is connectable or connected (11, 29) with the attachment (1), wherein
the pivot axes (27, 31) of the second pivot ever (14) are vertically adjustable relative to each other.

2. The connecting device according to claim 1, wherein the second pivot lever (14) is formed as multiple joint, in particular as four-bar linkage (19) with four struts (20, 21, 22, 23).

3. The connecting device according to claim 1, wherein the second pivot lever (14) comprises two vertical struts (21, 23) and two horizontal struts (20, 22) which are pivotally (24) connected with each other.

4. The connecting device according to claim 3, comprising a drivable adjusting rod (25) which is pivotally (26) connected with two struts (20, 22), preferably with the two horizontal struts.

5. An attachment for a self-propelled working machine, comprising a connecting device according to claim 1.

6. A self-propelled working machine, in particular a combine-harvester, comprising a connecting device according to claim 1.

7. A self-propelled working machine, in particular a combine-harvester, comprising a connecting device according to claim 1 and an attachment.

8. The connecting device according to claim 2, wherein the second pivot lever (14) comprises two vertical struts (21, 23) and two horizontal struts (20, 22) which are pivotally (24) connected with each other.

9. The connecting device according to claim 8, comprising a drivable adjusting rod (25) which is pivotally (26) connected with two struts (20, 22), preferably with the two horizontal struts.

10. An attachment for a self-propelled working machine, comprising a connecting device according to claim 9.

11. An attachment for a self-propelled working machine, comprising a connecting device according to claim 8.

12. An attachment for a self-propelled working machine comprising a connecting device according to claim 4.

13. An attachment for a self-propelled working machine, comprising a connecting device according to claim 3.

14. An attachment for a self-propelled working machine, comprising a connecting device according to claim 2.

15. A self-propelled working machine, in particular a combine-harvester, comprising a connecting device according to claim 9 and an attachment.

16. A self-propelled working machine, in particular a combine-harvester, comprising a connecting device according to claim 8 and an attachment.

17. A self-propelled working machine, in particular a combine-harvester, comprising a connecting device according to claim 4 and an attachment.

18. A self-propelled working machine, in particular a combine-harvester, comprising a connecting device according to claim 3 and an attachment.

19. A self-propelled working machine, in particular a combine-harvester, comprising a connecting device according to claim 2 and an attachment.

20. A self-propelled working machine, in particular a combine-harvester, comprising a connecting device according to claim 9.
